(19) United States
(12) Patent Application Publication
(10) Pub. No.: US 2010/0129773 A1
(43) Pub. Date: May 27, 2010

(54) ENGAGEABLE ABUTMENT FOR A TOOTH

(76) Inventor: Chun-Leon CHEN, Changhua City (TW)

Correspondence Address: Guice Patents PLLC, 12647 Galveston Court #302, Manassas, VA, 20112, US

(21) Appl. No.: 12/276,455

(22) Filed: Nov. 24, 2008

(51) Int. Cl. A61C 8/00

(52) U.S. Cl. 433/174

(57) ABSTRACT

An engageable abutment, the structure of the engageable abutment is designed to have an engageable sleeve on a base; the engageable sleeve has three functions: 1. It is adapted to being formed thereover a contemporary tooth crown that can be used for waiting healing of gingiva. 2. It has the function of transfer copying, and can be taken out; when in cast making an eternal tooth crown, the eternal tooth crown can be directly shaped in the sleeve for the convenience of fast and accurate assembling of the eternal tooth crown on the base. 3. It can alternatively be provided thereover with an eternal movable artificial tooth. Therefore, the present invention has a plurality of functions beneficial to processing of a dental implant surgical operation.

### BACKGROUND OF THE INVENTION

1. Field of the invention

The present invention relates to an engageable abutment, and especially to an engageable abutment structure composed of a base and a sleeve and being connected between an implant root and a tooth crown in a surgical operation of a tooth.

2. Description of the Prior Art

As to a dental implant surgical operation available presently, FIG. 1 shows a structure for the dental implant surgical operation which mainly has a jawbone 91 missing a natural tooth 96 implanted therein in advance with an implant root 92 which is a screw shape fixture, and when the wounds of the implant root 92 and the jawbone 91 are healed, an abutment 93 is mounted on the implant root 92 with a bolt 95, then the abutment 93 is mounted thereon with an artificial tooth crown 94.

A conventional abutment 93 is a single piece member, it only is used as a connecting member between the tooth crown 94 and the implant root 92. During the process of a surgical operation of a tooth, after the abutment 93 is mounted, a tooth mold shall be made to be sent to a factor for making a suitable tooth crown 94 that will be assembled on the abutment 93. By virtue that an inner hole of the tooth crown 94 made with the tooth mold is subjected to having difference from the abutment 93, so that difficulty often exists in assembling, if in a serious case, the tooth crown 94 is made once more. This is the defect resided in the structure of a conventional abutment, and improvement is required.

### SUMMARY OF THE INVENTION

The present invention provides an engageable abutment against the defect of the conventional abutment, the engageable abutment is designed to have an engageable sleeve on a base; the engageable sleeve has three functions: 1. It is adapted to being formed thereover a contemporary tooth crown that can be used for waiting healing of gingiva. 2. It has the function of transfer copying, and can be taken out; when in cast making an eternal tooth crown, the eternal tooth crown can be directly shaped in the sleeve for the convenience of fast and accurate assembling of the eternal tooth crown on the base. 3. It can alternatively be provided thereover with an eternal movable artificial tooth. Therefore, the present invention has a plurality of functions beneficial to processing of a dental implant surgical operation.

Moreover, the engageable abutment provided in the present invention comprises a base and a sleeve, the base or the sleeve can be cut off a part to adjust height.

The present invention will be apparent in its structure and its effect of operation after reading the detailed description of the preferred embodiment thereof in reference to the accompanying drawings.

### BRIEF DESCRIPTION OF THE DRAWINGS

FIG. 1 is a schematic sectional view showing a conventional dental implanting structure;

FIG. 2 is an anatomic perspective view showing a first embodiment of the present invention;

FIG. 2A is a sectional view showing a base in FIG. 2;

FIG. 3 is a sectional view of the first embodiment of the present invention after assembling;

FIG. 4 is a schematic sectional view showing that the first embodiment of the present invention is mounting in gingival;

FIG. 5 is a sectional view showing a second embodiment of the present invention;

FIG. 5A is a schematic sectional view showing that the base of FIG. 5 is cut off a part to adjust height;

FIG. 6 is a sectional view showing another embodiment of sleeve of the present invention;

FIG. 6A is a schematic sectional view showing that the sleeve of FIG. 6 is cut off a part to adjust height;

FIG. 7 is a sectional view showing another embodiment of the present invention.

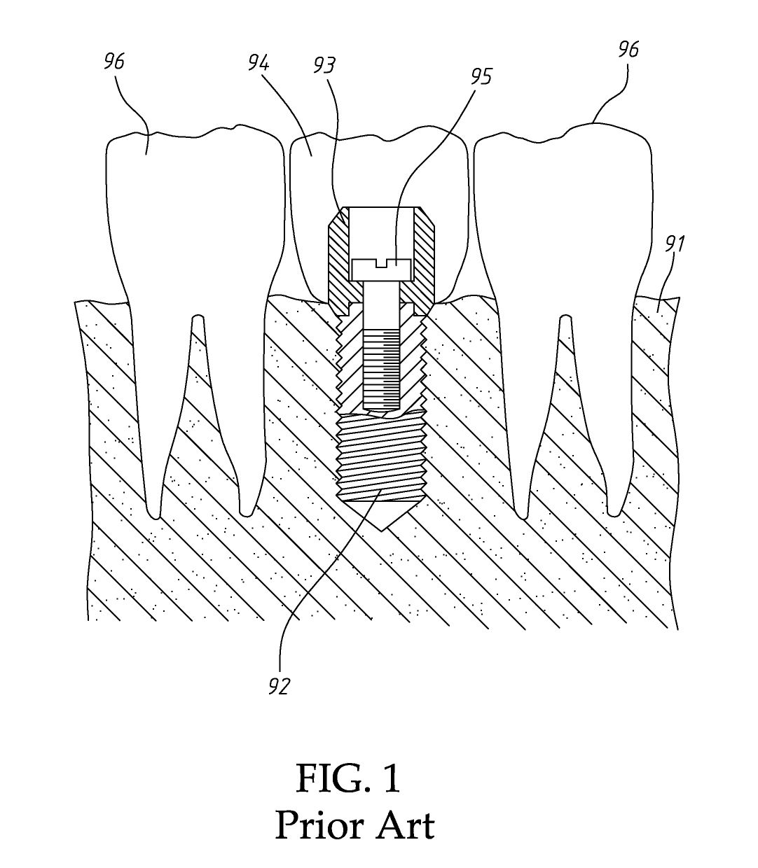

### DETAILED DESCRIPTION OF THE PREFERRED EMBODIMENT

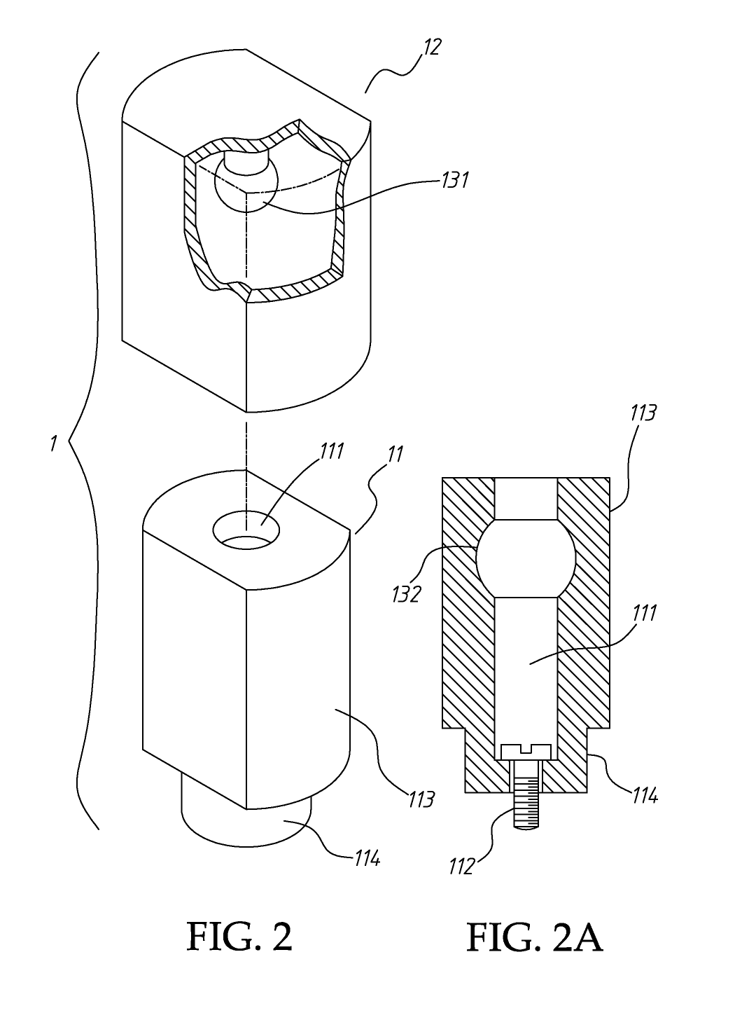

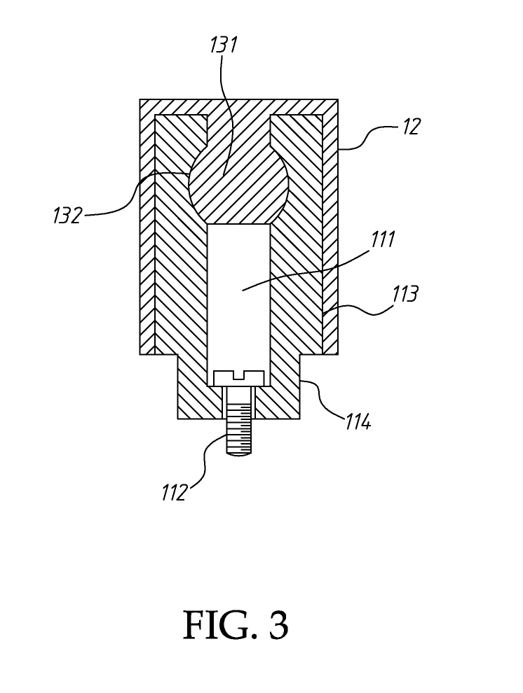

Referring to FIGS. 2-4, an engageable abutment 1 of the present invention mainly comprises a base 11, a sleeve 12 and a set of engaging mechanism, and is connected between an implant root 2 and a tooth crown 3.

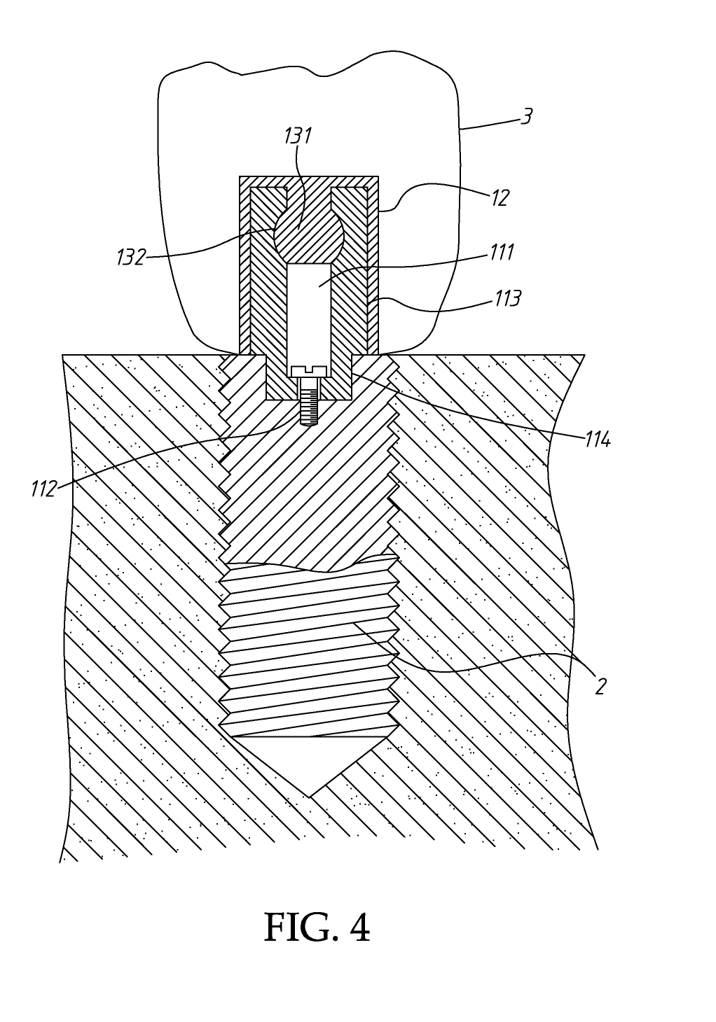

The base 11 of the present invention has therein a through hole 111 for extending through of a screw 112, such as is shown in FIG. 2; the base 11 thus can be connected and locked on the top of the implant root 2, and a protruding portion 113 (referring also to FIG. 4) is formed above the implant root 2, the protruding portion 113 has on its lower end an embedding portion 114 to be embedded in the implant root 2. The sleeve 12 can be formed thereover an eternal tooth crown or a contemporary tooth crown and is slipped over the protruding portion 113 of the base 11. The set of engaging mechanism mainly includes a protruding ball 131 and at lease a recess 132, the protruding ball 131 is provided in the sleeve 12, for example, as shown in the drawing, it is provided in an upper inside area of the sleeve 12 to extend downwards; while the recess 132 engaging the protruding ball 131 is provided in the base 11, in the drawing for instance, it is provided in and at a middle level of the through hole 111 in the base 11 which allows the screw 112 to be extended through.

After the sleeve 12 of the present invention is slipped over the protruding portion 113 of the base 11, the protruding ball 131 in the sleeve 12 will be engaged by the recess 132 in the base 11 to render the sleeve 12 and the base 11 to be positioned and fixed.

In the structure of the present invention, the base 11 of the engageable abutment 1 is designed to have the sleeve 12 for engaging, the sleeve 12 has the following three functions: Firstly: the sleeve 12 is adapted to being formed on its outer surface a contemporary tooth crown that can be used for waiting healing of the implant root 2 and gingiva. Secondly: the sleeve 12 has the function of transfer copying, and can be taken out; when in cast making an eternal tooth crown, the eternal tooth crown can be directly shaped in the sleeve 12 for the convenience of fast and accurate assembling of the eternal tooth crown on the base 11. And thirdly: the sleeve 12 can alternatively be provided thereover with an eternal movable artificial tooth. Therefore, the present invention has a plurality of functions beneficial to processing a dental implant surgical operation.

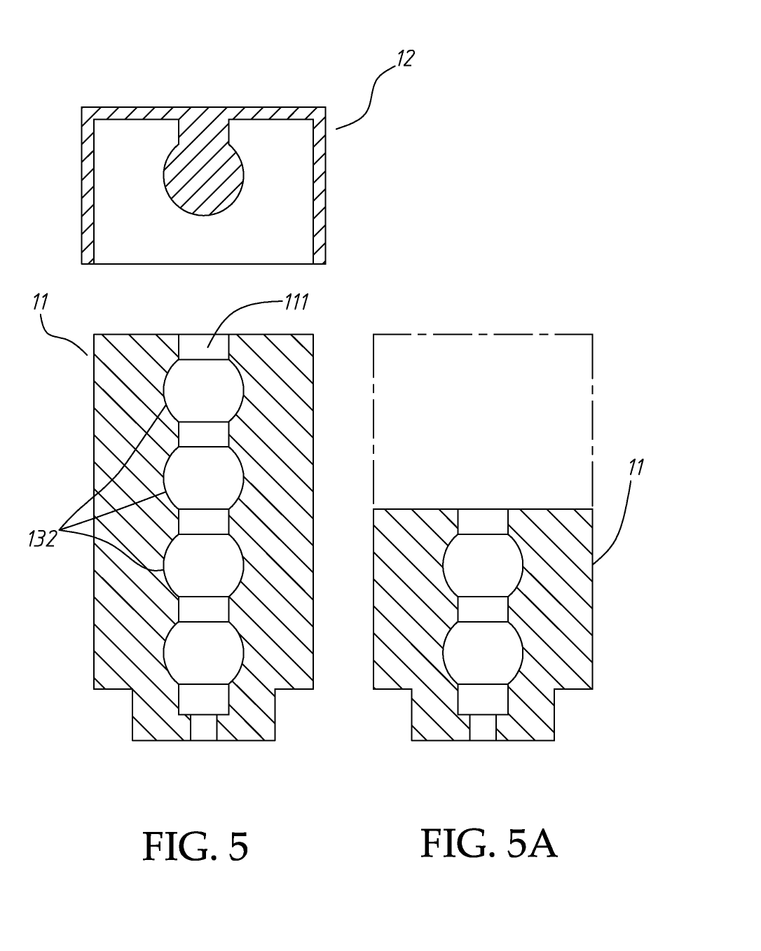

Moreover, as shown in FIG. 5 which shows a second embodiment of the present invention, wherein the sleeve 12 is same as that of the first embodiment, but a plurality of recesses 132 are provided in the base 11 and are lined downwards from above along the through hole 111. In this case, the base 11 can be cut off a part at any area between every two recesses 132 to adjust height, such as is shown in FIG. 5A, wherein a dot and dash line represents a portion is cut out from FIG. 5.

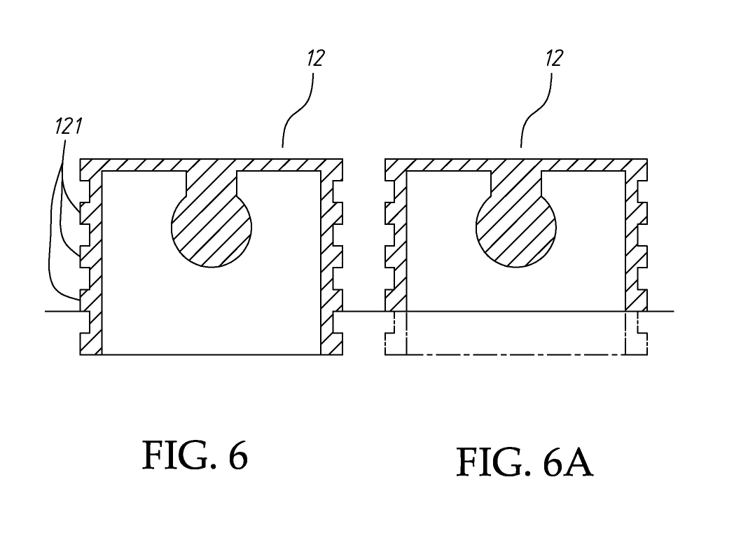

Referring to FIG. 6 which shows another embodiment of sleeve 12 of the present invention, wherein the sleeve 12 is formed thereon apparently a plurality of annuluses 121, as compared with FIG. 6A, the sleeve 12 in FIG. 6A can be cut at the bottom of any annulus 121 to adjust height, such as is shown with a dot and dash line.

The base 11 and the sleeve 12 are designed to be adjustable in height to suit a particular tooth of a person in need of tooth implanting.

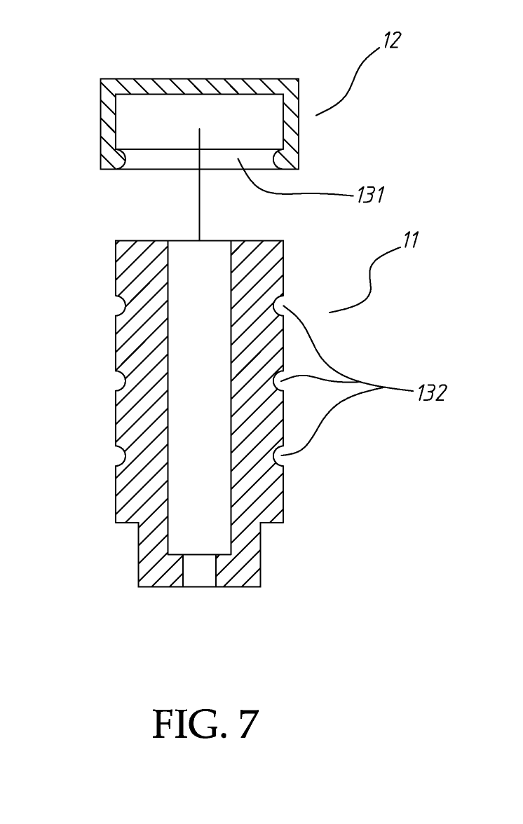

Surely, the protruding ball 131 of the present invention is not limited to being provided in an upper inside area of the sleeve 12, as shown in FIG. 7, a protruding ball 131 is provided at the bottom edge of the sleeve 12, while recesses 132 are provided on the outer surface of the base 11; the recesses 132 are also plural, they are arranged to be lined downwards from above along the base 11, the base 11 can be cut at a position where any recess 132 is, in order to adjust height.

In conclusion, the engageable abutment of the present invention has a brand new structure and very improved effect; therefore, what we claim will be declared in the claims followed.

1. An engageable abutment, being connected between an implant root and a tooth crown and comprising:
a base, being mounted on an implant root with a bolt, said implant root being formed thereabove a protruding portion;
a sleeve, being slipped over a protruding portion of said base; and
a set of engaging mechanism, including a protruding ball provided in said sleeve, and at lease a recess adapted to engaging said protruding ball and being provided in said base;
said sleeve is slipped over said protruding portion of said base, and said protruding ball engaged by said recess renders said sleeve and said base to be positioned and fixed.

2. The engageable abutment as claimed in claim 1, wherein said sleeve is formed thereover an eternal tooth crown or a contemporary tooth crown.

3. The engageable abutment as claimed in claim 1, wherein said protruding ball is provided in an upper inside area of said sleeve to extend downwards, while said recess is provided in said base and allows a screw to be extended through a through hole.

4. The engageable abutment as claimed in claim 3, wherein said at lease a recess means plural recesses, said recesses are lined downwards from above along said through hole in said base, said base is adapted to being cut off a part at any area between every two recesses to adjust height.

5. The engageable abutment as claimed in claim 4, wherein said sleeve is formed thereon apparently a plurality of annuluses, said sleeve is cut at a bottom of any of said annuluses to adjust height.

6. The engageable abutment as claimed in claim 1, wherein said protruding ball is provided at a bottom edge of said sleeve, while said recess are provided on an outer surface of said base.

7. The engageable abutment as claimed in claim 6, wherein said recesses are provided on an outer surface of said base, and are arranged to be lined downwards from above along said base, said base is adapted to being cut at a position where any of said recesses is, in order to adjust height.
